(19) United States
(12) Patent Application Publication
(10) Pub. No.: US 2017/0130748 A1
(43) Pub. Date: May 11, 2017

(54) MULTI-OUTPUT CHARGING DEVICE

(71) Applicant: BorgWarner Inc., Auburn Hills, MI (US)

(72) Inventors: Brett Peglowski, Oakland, MI (US); David Vierk, Mokena, IL (US); Jeff Waterstredt, Royal Oak, MI (US); Feng Dong, Rochester, MI (US)

(21) Appl. No.: 14/933,060

(22) Filed: Nov. 5, 2015

(51) Int. Cl. F15B 15/14

(52) U.S. Cl. CPC F15B 15/14; F15B 2211/20523

(57) ABSTRACT

A vehicle having a device that uses an input provided from a first hydraulic system to charge one or more other hydraulic systems. The first hydraulic system can be a vehicle brake system or a hydraulic system having an electrically operated pump. The hydraulic systems to be charged could include an engine lubrication system and/or a transmission hydraulic control system.

### FIELD

The present disclosure relates to a multi-output charging device for charging one or more devices in a hydraulic system.

### BACKGROUND

This section provides background information related to the present disclosure which is not necessarily prior art.

One technique for improving vehicle fuel economy is to employ a start-stop engine control that halts the operation of a vehicle's internal combustion engine in certain circumstances, such as when the vehicle is stopped at a stop light. It has been proposed that the start-stop engine control technique be expanded to include vehicle coasting or sailing—events where the driver of the vehicle has removed her/his foot from the accelerator pedal and permits the vehicle to continue motion based on its own momentum. One drawback associated with the integration of start-stop engine control into some vehicles is associated with the operation of their hydraulic systems (e.g., power steering system) during times at which the internal combustion engine is not operated. Generally, each of the hydraulic systems includes a pump that is driven by the internal combustion engine, typically via a front engine accessory drive. When the internal combustion engine is not operating, the pump for each of the hydraulic systems is not provided with rotary power and cannot provide pressurized fluid for operating the hydraulic system.

Various solutions have been proposed to address the aforementioned problem, including the use of hydraulic accumulators, which are configured to store and release pressurized hydraulic fluid, and electric motors that are configured to selectively operate an associated one of the pumps. One drawback with such techniques is that the additional components can be relatively costly and/or difficult to package into a given vehicle.

### SUMMARY

This section provides a general summary of the disclosure, and is not a comprehensive disclosure of its full scope or all of its features.

In one form, the present teachings provide a vehicle that includes first and second hydraulic systems, first and second pressurized fluid delivery devices, a first cylinder device and a valve assembly. The first hydraulic system has a first fluid that is configured to operate a first component. The first pressurized fluid delivery device is configured to be driven by an internal combustion engine. The first pressurized fluid delivery device is a first pump that is configured to supply the first fluid in a pressurized state to the first component when the first pump is driven. The second pressurized fluid delivery device is configured to output a second fluid in a pressurized state. The second fluid is different from the first fluid. The first cylinder device has a first input cylinder assembly and a first output cylinder assembly. The first input cylinder assembly has a first input cylinder housing and a first input piston that is slidably received in the first input cylinder housing. The first output cylinder assembly has a first output cylinder housing and a first output cylinder piston. The first output cylinder housing is fixedly coupled to the first input cylinder housing. The first output piston is slidably received in the first output cylinder housing and is coupled to the first input piston for movement therewith. The first output cylinder assembly is coupled in fluid connection to the first component to transmit the first fluid therebetween. The valve assembly is disposed between the second pressurized fluid delivery device and the first input cylinder assembly, the valve assembly is configured to selectively couple the second pressurized fluid delivery device to the first input cylinder assembly.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIGS. 1 and 2 are schematic illustrations of exemplary vehicles constructed in accordance with the teachings of the present disclosure, the vehicle having a charging device having multiple outputs for charging hydraulic systems when an internal combustion engine of the vehicle is not in operation.

Corresponding reference numerals indicate corresponding parts throughout the several views of the drawings.

### DETAILED DESCRIPTION

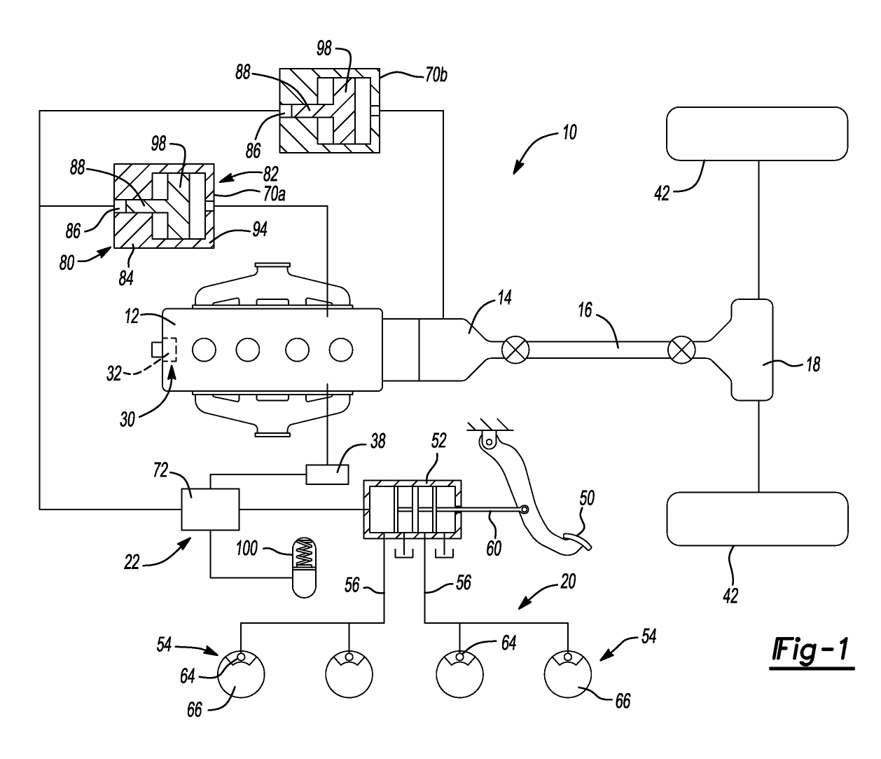

With reference to FIG. 1, an exemplary vehicle constructed in accordance with the teachings of the present disclosure is generally indicated by reference numeral 10. In the particular example provided, the vehicle 10 includes an internal combustion engine 12, a transmission 14, a propshaft 16, a rear axle assembly 18, a brake system 20 and an auxiliary hydraulic pressure system 22. The internal combustion engine 12 can be conventional in its construction and operation and is configured to supply rotary power to the transmission 14. The internal combustion engine 12 can include a hydraulic system (i.e., engine lubricant system 30) having an oil pump 32, which can be driven by the engine crankshaft during operation of the internal combustion engine 12, and a plurality of hydraulic devices (e.g., a variable cam timing mechanism, hydraulic lifters) that receive pressurized fluid from the oil pump 32.

The internal combustion engine 12 can be operated by a control unit 38 that employs a start-stop technique for operating the internal combustion engine 12. Accordingly, it will be appreciated that during operation of the vehicle 10, the control unit 38 can control the internal combustion engine 12 so that the internal combustion engine 12 does not operate and thereby does not provide rotatory power to the transmission 14.

The transmission 14 can be conventional in its construction and operation and is configured to supply rotary power to the propshaft 16, which transmits the rotary power to the rear axle assembly 18 for use in driving a set of rear vehicle wheels 42 to propel the vehicle 10. While the vehicle 10 is illustrated as having a rear-wheel drive configuration, it will be appreciated that the teachings of the present disclosure have application to vehicles having any type of vehicle driveline, including all-wheel drive, front wheel drive, four wheel drive, etc. The transmission 14 can be an automatic transmission that employs hydraulic power to move various valve elements (not specifically shown) and/or actuators to operate various clutches (not specifically shown) that control a gear ratio in which the transmission 14 operates. Accordingly, it will be appreciated that the transmission 14 comprises a transmission hydraulic control system that employs a hydraulic (transmission) fluid that is pressurized by a transmission fluid pump.

The brake system 20 conventionally includes a brake pedal 50, a master cylinder 52, a plurality of brake calipers 54 and a plurality of brake lines 56 that connect the master cylinder 52 to each of the brake calipers 54. It will be appreciated that the brake system 20 is shown in a very simplified form and could include other components that would provide power braking capabilities (e.g., vacuum assisted power braking), anti-lock braking capabilities and/or traction control capabilities. Briefly, movement of a rod 60 associated with the master cylinder 52 (e.g., by depressing the brake pedal 50) generates hydraulic pressure that is transmitted through the several brake lines 56 to the brake calipers 54 where caliper pistons 64 urge a pair of brake pads (not specifically shown) into contact with a rotor 66 to apply a braking force to the vehicle wheels to slow or arrest movement of the vehicle 10. It will be appreciated that the master cylinder 52 forms a type of hydraulic pump that outputs pressurized hydraulic fluid (i.e., a brake fluid) to and receives hydraulic fluid from the caliper pistons.

The auxiliary hydraulic pressure system 22 can be configured to provide pressurized hydraulic fluid to one or more of the hydraulically powered systems in the vehicle 10 (e.g., the engine lubricant system 30 and/or the transmission 14) during times at which the internal combustion engine 12 is not operating. The auxiliary hydraulic pressure system 22 can include one or more cylinder devices (e.g., cylinder devices 70a and 70b) and a control valve 72. Each of the cylinder devices 70a, 70b can be constructed in the form a hydraulic intensifier having an input cylinder assembly 80 and an output cylinder assembly 82. The input cylinder assembly 80 can have an input cylinder housing 84, which can define a first port 86, and a first or input piston 88 that is slidably received in the input cylinder housing 84. The output cylinder assembly 82 can have an output cylinder housing 94, which can define a second port 96, and an output piston 98. The output cylinder housing 94 can be fixedly coupled to the input cylinder housing 84. The first output piston 88 can be slidably received in the output cylinder housing 94 and can be coupled to the input piston 88 for common axial movement. The input piston 88 can have a first area and the first output piston 88 can have a second area that is relatively larger than the first area.

Typically, an intensifier is operated such that an input having a relatively low pressure and relatively high volume is provided to the piston having the larger area; the pressure of the input fluid acting on the relatively large volume produces a force on the larger area piston that is transmitted to the smaller area piston; because the force acting on the smaller area piston acts over a smaller area, a relatively higher pressure, relatively lower volume output is produced. In the present situation, however, the auxiliary hydraulic pressure system 22 is configured such that an input having a relatively low volume and relatively high pressure is provided to the smaller area piston (i.e., the input piston 88) to thereby create an output having a relatively lower pressure but relatively higher volume. For example, fluid discharged from the second port 96 of the first cylinder device 70a can be directed into the engine lubricant system 30 to provide pressurized lubricant to various components of the internal combustion engine 12. As another example, fluid discharged from the second port of the cylinder device 70b can be directed into the transmission 14 to control the operation of various valve and actuators that set the transmission 14 into a desired gear ratio.

The control valve 72 can be a directional valve that can be coupled in fluid connection to a pressurized fluid delivery device and to the first ports 86 of the cylinder devices 70a, 70b. The control valve 72 can have a valve element that is movable to cause the control valve 72 to operate in a first valve condition, which fluidly decouples the pressurized fluid delivery device from the first ports 86, and a second valve condition that fluidly couples the pressurized fluid delivery device to the first ports 86. The control valve 72 can be a solenoid-operated, spring return valve in which the control valve 72 normally operates in the first valve condition but can be operated in the second valve condition in response to receipt of a control signal generated by the control unit 38. The pressurized fluid delivery device can be the master cylinder 52.

During operation of the vehicle 10, the brake system 20 can be operated to arrest movement of the vehicle 10 (e.g., to stop the vehicle 10 at a traffic light). When various vehicle parameters fall within predetermined ranges, the control unit 38 can halt the operation of the internal combustion engine 12 in accordance with a start-stop algorithm. It will be appreciated that fluid pressure produced by the master cylinder 52 is transmitted through the control valve 72 to the caliper pistons 64 when the control valve 72 is operated in the first valve condition.

The control unit 38 can generate a control signal while the brake pedal 50 is depressed that can be received by the control valve 72 and the control valve 72 can responsively transition to the second valve condition to thereby fluidly couple the master cylinder 52 (and the brake calipers 54) to the cylinder devices 70a, 70b so that a relatively lower pressure, higher volume of fluid can be delivered to the engine lubricant system 30 and the transmission 14, respectively, for operation of these hydraulic systems when the internal combustion engine is not in operation. In addition to reducing the amount of time that is required to fully pressurize these systems upon restarting the internal combustion engine 12, the provision of pressurized fluid to engine lubricant system 30 and/or the transmission 14 can significantly reduce wear that might otherwise occur from a lack of lubrication in the internal combustion engine 12 and/or the transmission 14 and improve the quality of vehicle launch.

While the pressurized fluid delivery device that provides an input to the cylinder devices 70a, 70b has been described as being the master cylinder 52, it will be appreciated that the pressurized fluid delivery device could comprise one or more other devices in addition to or in lieu of the master cylinder 52, including an anti-lock brake pump. For example, the pressurized fluid delivery device could additionally comprise an accumulator 100 that is in fluid connection with the control valve 72. When the control valve 72 is in the first valve condition, the accumulator 100 is not coupled in fluid communication with the master cylinder 52, the caliper pistons 64 or the cylinder devices 70a, 70b. When the control valve 72 is in the second valve condition, however, the control valve 72 couples the accumulator 100 in fluid communication with the master cylinder 52, the caliper pistons 64 and the cylinder devices 70a, 70b to thereby increase the amount of pressurized hydraulic fluid that is available for use as an input to the cylinder devices 70a, 70b. The control unit 38 can withdraw or halt the generation of the control signal to cause the control valve 72 to revert to the first valve condition at the end of a start-stop cycle when the internal combustion engine 12 is to be restarted.

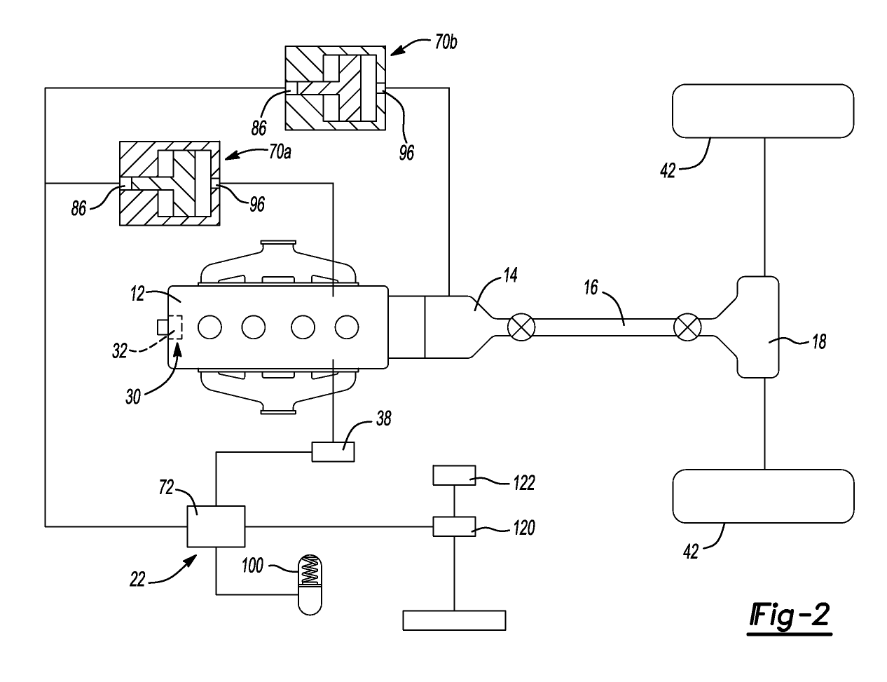

The example of FIG. 2 is generally similar to that of FIG. 1, except that the source of pressurized hydraulic fluid for operating the cylinder devices 70a, 70b is an electrically-driven pump, such as a power steering pump 120 that is employed in a drive-by-wire steering system and selectively driven by an electric motor 122.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A vehicle comprising:
a first hydraulic system having a first fluid for operating a first component;
a first pressurized fluid delivery device that is adapted to be driven by an internal combustion engine, the first pressurized fluid delivery device being a first pump that is configured to supply the first fluid in a pressurized state to the first component when the first pump is driven;
a second pressurized fluid delivery device that is configured to output a second fluid in a pressurized state, the second fluid being different from the first fluid;
a first cylinder device having a first input cylinder assembly and a first output cylinder assembly, the first input cylinder assembly having a first input cylinder housing and a first input piston that is slidably received in the first input cylinder housing, the first output cylinder assembly having a first output cylinder housing and a first output cylinder piston, the first output cylinder housing being fixedly coupled to the first input cylinder housing, the first output piston being slidably received in the first output cylinder housing and being coupled to the first input piston for movement therewith, the first output cylinder assembly being coupled in fluid connection to the first component to transmit the first fluid therebetween; and
a valve assembly between the second pressurized fluid delivery device and the first input cylinder assembly, the valve assembly being configured to selectively couple the second pressurized fluid delivery device to the first input cylinder assembly.

2. The vehicle of claim 1, wherein the second pressurized fluid delivery device comprises a second pump.

3. The vehicle of claim 2, wherein the second pump is an axial pump.

4. The vehicle of claim 2, wherein the second pump is a master cylinder of a vehicle brake system.

5. The vehicle of claim 2, wherein the second pump is driven by an electric motor.

6. The vehicle of claim 1, wherein the second pressurized fluid delivery device comprises an accumulator.

7. The vehicle of claim 1, further comprising:
a second hydraulic system having a third fluid for operating a second component;
a second pressurized fluid delivery device that is adapted to be driven by an internal combustion engine, the second pressurized fluid delivery device being a second pump that is configured to supply the third fluid in a pressurized state to the second component when the second pump is driven; and
a second cylinder device having a second input cylinder assembly and a second output cylinder assembly, the second input cylinder assembly having a second input cylinder housing and a second input piston that is slidably received in the second input cylinder housing, the second output cylinder assembly having a second output cylinder housing and a second output cylinder piston, the second output cylinder housing being fixedly coupled to the second input cylinder housing, the second output piston being slidably received in the second output cylinder housing and being coupled to the second input piston for movement therewith, the second output cylinder assembly being coupled in fluid connection to the second component to transmit the third fluid therebetween;
wherein the valve assembly is also disposed between the second pressurized fluid delivery device and the second input cylinder assembly, the valve assembly being configured to selectively couple the second pressurized fluid delivery device to the second input cylinder assembly.

8. The vehicle of claim 7, wherein the first output piston defines a first area that acts on the first fluid, wherein the second output piston defines a second area that acts on the third fluid, and wherein the first and second areas are different.

9. The vehicle of claim 7, wherein one of the first and second hydraulic systems comprises an engine lubrication system.

10. The vehicle of claim 9, wherein the other one of the first and second hydraulic systems comprises a transmission hydraulic control system.

11. The vehicle of claim 1, wherein the first hydraulic system comprise at least one of an engine lubrication system and a transmission hydraulic control system.
